(19) United States
(12) Patent Application Publication
(10) Pub. No.: US 2024/0367613 A1
(43) Pub. Date: Nov. 7, 2024

(54) FLOW PATH SWITCHING DEVICE AND VEHICLE CLEANING DEVICE

(71) Applicant: DENSO CORPORATION, Kariya-city (JP)

(72) Inventor: Shota ADACHI, Kariya-city (JP)

(73) Assignee: DENSO CORPORATION, Kariya-city (JP)

(21) Appl. No.: 18/774,027

(22) Filed: Jul. 16, 2024

Related U.S. Application Data
(63) Continuation of application No. PCT/JP2023/005859, filed on Feb. 17, 2023.

(30) Foreign Application Priority Data
Feb. 24, 2022 (JP) 2022-026660

(51) Int. Cl. B60S 1/48; B60S 1/58

(52) U.S. Cl. CPC B60S 1/481; B60S 1/58

(57) ABSTRACT

A flow path switching device can selectively output fluid supplied from a drive pump from either the first output section or the second output section. The device includes a switching valve configured to, in response to a drop in pressure occurring in either of a first output section or a second output section, switch fluid flow to one of the first output section or the second output section in which the pressure drop did not occur.

### CROSS-REFERENCING OF RELATED APPLICATION

The present application is a continuation application of International Application No. PCT/JP2023/005859, filed on Feb. 17, 2023, which claims priority to Japanese Patent Application No. 2022-026660, filed on Feb. 24, 2022. The contents of these applications are incorporated herein by reference in their entirety.

### BACKGROUND

### 1. Technical Field

This disclosure relates to a flow path switching device and a vehicle cleaning device.

### 2. Related Art

In recent years, vehicles may be equipped with a plurality of sensors to monitor the surrounding situations of the vehicles. A sensing surface (e.g., lenses, cover glass, and other external surfaces) of each of the plurality of sensors is externally exposed from the vehicle. Therefore, foreign matter such as raindrops may adhere to the sensing surfaces. A system including sensors may not function properly when foreign matter adheres to the sensing surfaces. Therefore, it is necessary to clean the sensing surface of each sensor. Thus, a vehicle may have multiple cleaning targets. JP2004-182080A discloses a vehicle cleaning device, which is installed in a vehicle and has a solenoid valve that switches the flow path by switch operation. The vehicle cleaning device described in JP 2004-182080 can spray fluid supplied from a single drive pump to two cleaning targets, respectively.

### SUMMARY

A flow path switching device of the first aspect of the present disclosure can selectively output fluid supplied from a drive pump from either the first output section or the second output section. The device includes a switching valve configured to, in response to a drop in pressure occurring in either of a first output section or a second output section, switch fluid flow to one of the first output section or the second output section in which the pressure drop did not occur.

A vehicle cleaning device of the second aspect of the present disclosure includes the flow path switching device of the first aspect of the present disclosure. In the vehicle cleaning device, the first output section is a first nozzle for spraying the fluid onto the first cleaning target, and the second output part is a second nozzle for spraying the fluid onto the second cleaning target.

### BRIEF DESCRIPTION OF THE DRAWINGS

The objectives and other purposes, features and advantages with respect to this disclosure will become clearer in the following detailed description with reference to the accompanying drawings.

In the accompanying drawings:

FIG. 1 is a schematic diagram of a vehicle cleaning system in one embodiment,

FIG. 2 is a diagram of the vehicle cleaning system in one embodiment,

FIG. 3 shows a cross-sectional view of the vehicle cleaning system in one embodiment,

FIG. 4 shows a cross-sectional view of a switching valve in one embodiment,

FIG. 5 is a cross-sectional view for explaining the operation of the switching valve in one embodiment,

FIG. 6 shows a cross-sectional view of first and second pressure storage valves, etc. in one embodiment,

FIG. 7 shows a partial cross-sectional view of the first and second storage valves in one embodiment,

FIG. 8 is a cross-sectional view for explaining the operation of the first and second pressure storage valves in one embodiment,

FIG. 9 is a cross-sectional view for explaining the operation of the first and second pressure storage valves in one embodiment.

### DETAILED DESCRIPTION OF THE PREFERRED EMBODIMENTS

The vehicle cleaning device described in JP2004-182080A requires a solenoid valve, wires connected to the solenoid valve, and a control unit to control the solenoid valve. This makes the device more complicated.

The purpose of the present disclosure is to provide a flow path switching device and a vehicle cleaning device that enable simplification of the configuration.

A flow path switching device of the first aspect of the present disclosure can selectively output fluid supplied from a drive pump from either the first output section or the second output section. The device includes a switching valve configured to, in response to a drop in pressure occurring in either of a first output section or a second output section, switch fluid flow to one of the first output section or the second output section in which the pressure drop did not occur.

According to the first aspect of the present disclosure, output of the fluid from one of the first output section or the second output section causes the pressure in the corresponding flow path to drop, thereby the flow of the fluid is switched to the other one of the first output section or the second output section. Thus, the fluid supplied from a single drive pump can be mechanically switched to either one of the first output section or the second output section. Therefore, the configuration can be simplified compared to a flow path switching device equipped with a solenoid valve or the like.

A vehicle cleaning device of the second aspect of the present disclosure includes the flow path switching device of the first aspect of the present disclosure. In the vehicle cleaning device, the first output section is a first nozzle for spraying the fluid to the first cleaning target, and the second output part is a second nozzle for spraying the fluid to the second cleaning target.

According to the second aspect of the present disclosure, the jetting of fluid from either the first or second nozzle causes the pressure in the corresponding flow path to drop, and thereby the flow of the fluid is switched to either the first or second nozzle. Therefore, fluid supplied from a single drive pump can be switched and injected from the first and second nozzles. Therefore, the configuration can be simplified compared to a vehicle cleaning device equipped with a solenoid valve or the like.

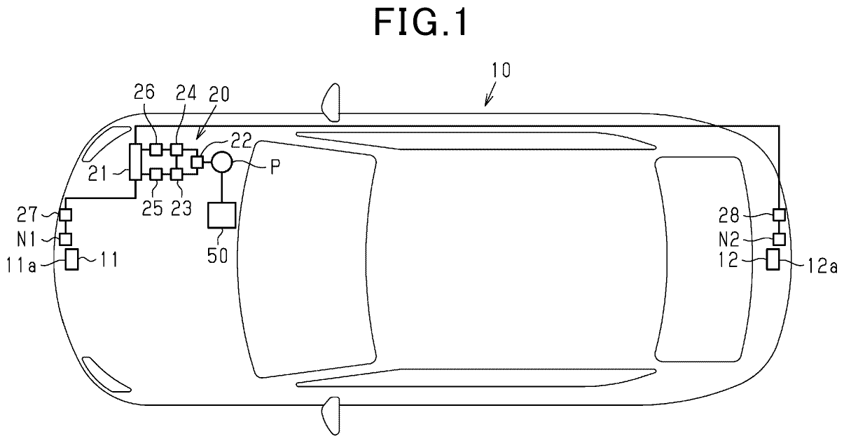

One embodiment of a vehicle cleaning system is described below according to FIGS. 1 through 9.

As shown in FIG. 1, a first distance-measuring sensor 11 is installed at the center of the front end of the vehicle 10, and a second distance-measuring sensor 12 is installed at the center of the rear end of the vehicle 10. The first distance-measuring sensor 11 is an optical sensor that projects light of a predetermined wavelength toward the front of the vehicle 10 and receives the reflected light. The second distance-measuring sensor 12 is an optical sensor that projects light of a predetermined wavelength toward the rear of the vehicle 10 and receives the reflected light. Each of the first distance-measuring sensor 11 and the second distance-measuring sensor 12 is used in a distance measurement system (such as LIDAR) that measures the distance between the vehicle 10 and objects in front of and behind the vehicle 10 and is used in systems that implement advanced driver assistance and automatic driving of the vehicle 10.

The sensing surface (e.g., outer surface of the lens or cover glass) 11a of the first distance-measuring sensor 11 and the sensing surface (e.g., outer surface of the lens or cover glass) 12a of the second distance-measuring sensor 12 are externally exposed from the vehicle 10. Foreign matter such as raindrops, etc., which may degrade ranging accuracy, can adhere to each of the sensing surface 11a and the sensing surface 12a. For this reason, the vehicle 10 is equipped with a vehicle cleaning device (flow path switching device) 20 that removes and cleans foreign matter adhering to each of the sensing surface 11a and the sensing surface 12a. The sensing surface 11a of the first distance-measuring sensor 11 is an example of the first cleaning target, and the sensing surface 12a of the second distance-measuring sensor 12 is an example of the second cleaning target.

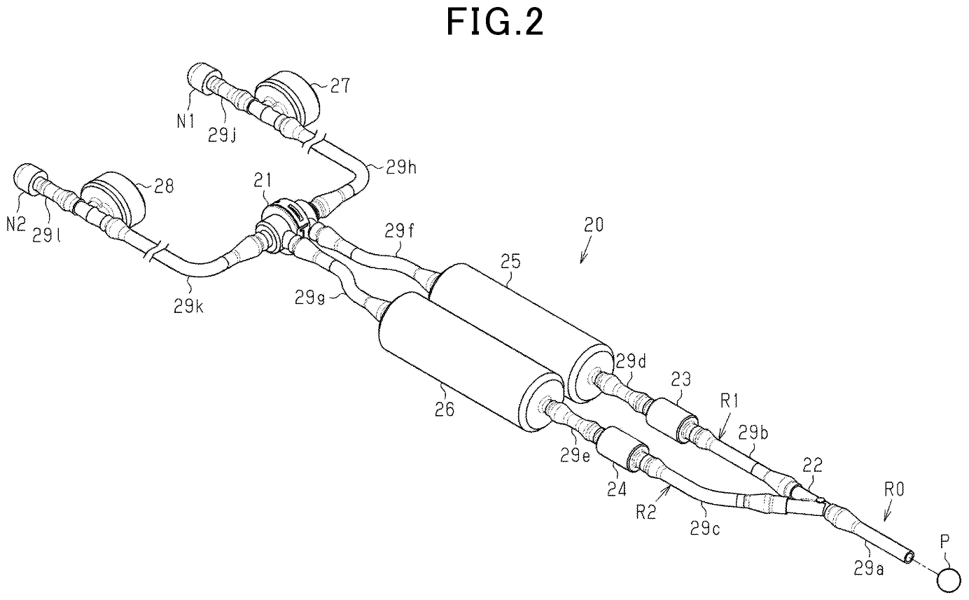

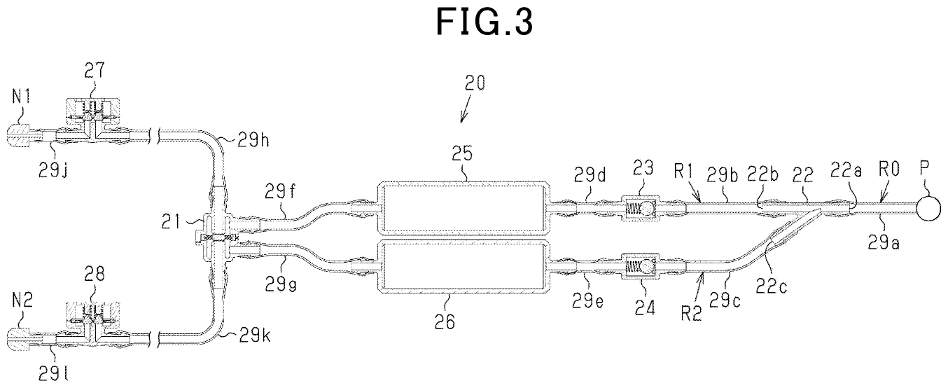

As shown in FIGS. 2 and 3, the vehicle cleaning system 20 outputs the fluid supplied from the drive pump P by switching between the first nozzle N1 and the second nozzle N2. The first nozzle N1 is an example of the first output section and the second nozzle N2 is an example of the second output section. The vehicle cleaning system 20 includes a drive pump P, a first nozzle N1, a second nozzle N2, a switching valve 21, a branch part 22, a first check valve 23, a second check valve 24, a first reservoir 25, a second reservoir 26, a first pressure storage valve 27, and a second pressure storage valve 28. The switching valve 21 is configured to switch the flow of the fluid to either the first nozzle N1 or the second nozzle N2 when the pressure in the flow path corresponding to one of the first nozzle N1 or the second nozzle N drops due to fluid flow from either one of the nozzles N1 or N2.

The drive pump P can generate compressed air CA1, which is an example of the fluid. The drive pump P is an electrically driven air pump, such as a gear pump, which is a positive displacement pump.

The branch part 22 has a source flow tube 22a, a first flow tube 22b, and a second flow tube 22c which interior spaces are connected to each other. The source flow tube 22a of the branch part 22 is connected to the drive pump P via a connection hose 29a. The branch part 22 divides the source flow path R0 of compressed air CA1 supplied from the drive pump P into a first flow path R1 and a second flow path R2 for distribution.

Each of the first check valve 23 and the second check valve 24 has, for example, a sphere and a spring inside to prevent backflow of compressed air CA1 into the branch part 22. The first check valve 23 is connected to the first flow path tube 22b of the branch part 22 via a connection hose 29b. The second check valve 24 is connected to the second flow tube 22c of the branch part 22 via a connecting hose 29c.

Each of the first reservoir 25 and the second reservoir 26 is, for example, formed as a cylinder and can store a predetermined volume of compressed air CA1. The volume in the first reservoir 25 may be larger, for example, than the volume in a connecting hose when the first check valve 23 and the switching valve 21 are directly connected by the connecting hose. The volume in the second reservoir 26 may be larger, for example, than the volume in a connecting hose when the second check valve 24 and the switching valve 21 are connected directly by the connecting hose. The first reservoir 25 is connected to the first check valve 23 via a connecting hose 29d. The second reservoir 26 is connected to the second check valve 24 via a connecting hose 29e.

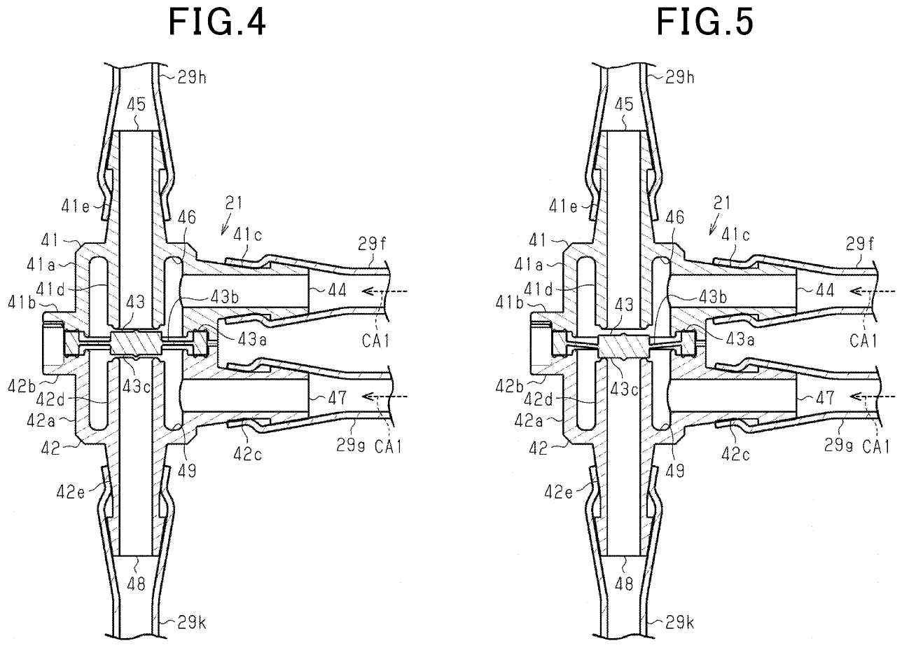

As shown in FIG. 4, the switching valve 21 has a first divider 41, a second divider 42, and a switching diaphragm 43, which is an example of “switching valve body” in the claims.

The first divider 41 forms a first inlet 44, a first discharge port 45, and a first valve chamber 46. The first valve chamber 46 connects the interior spaces of the first inlet 44 and the first discharge port 45. The second divider 42 forms a second inlet 47, a second discharge port 48 and a second valve chamber 49. The second valve chamber 49 connects the interior spaces of the second inlet 47 and the second discharge port 48. The switching diaphragm 43 is positioned between the first valve chamber 46 and the second valve chamber 49 to compartmentalize them. The switching diaphragm 43 blocks the flow of compressed air CA1 from the first inlet 44 to the first discharge port 45 or from the second inlet 47 to the second discharge port 48, depending on the pressure difference between the first valve chamber 46 and the second valve chamber 49. In other words, the switching diaphragm 43 allows compressed air CA1 to flow to the first discharge port 45 or the second discharge port 48 depending on the pressure difference between the inside of the first valve chamber 46 and the inside of the second valve chamber 49.

The first divider 41 is made of resin and has a body portion 41a, an outer edge 41b, a first inflow cylinder 41c, a first inner extending cylinder 41d, and a first outer extending cylinder 41e. The body portion 41a is formed in a truncated bottomed cylindrical shape. The outer edge 41b extends outwardly in the radial direction from an opening of the body portion 41a. The first inflow cylinder 41c protrudes cylindrically (protrudes in the form of a hollow cylinder) from a portion of the circumference of the body portion 41a and connects the outside space and the inside space of the body portion 41a. The first inner extending cylinder 41d protrudes cylindrically from the center of the bottom of the body portion 41a in an inward direction of the body portion 41a, i.e., cylindrically inside the first valve chamber 46. The first outer extending cylinder 41e protrudes cylindrically from the center of the bottom of the body portion 41a in the outward direction of the body portion 41a. The respective interiors of the first inner extending cylinder 41d and the first outer extending cylinder 41e have the same axis and their interior spaces are connected to each other. An opening formed at the tip of the first inflow cylinder 41c is the first inlet 44, and an opening formed at the tip of the first outer extending cylinder 41e is the first discharge port 45.

The second divider 42 is made of resin and has the same shape as the first divider 41. The second division 42 has a body portion 42a, an outer edge 42b, a second inflow cylinder 42c, a second inner extending cylinder 42d, and a second outer extending cylinder 42e. The body portion 42a is formed in an abbreviated bottomed cylindrical shape. The outer edge 42b is located outwardly from the opening of the body portion 42a with respect to the radial direction. The second inflow cylinder 42c protrudes cylindrically from a portion of the outer circumference of the body portion 42a and connects the outer and inner portions of the body portion 42a. The second inner extending cylinder 42d protrudes cylindrically from the center of the bottom of the body portion 42a in the inward direction of the body portion 42a, i.e., it protrudes cylindrically into the inside of the second valve chamber 49. The second outer extending cylinder 42e protrudes cylindrically from the center of the bottom of the body portion 42a in the outward direction of the body portion 42a. The respective interiors of the second inner extending cylinder 42d and the second outer extending cylinder 42e have the same axis and their interior spaces are connected to each other. The opening formed at the tip of the second inflow cylinder 42c is the second inlet 47, and the opening formed at the tip of the second outer extending cylinder 42e is the second discharge port 48.

The switching diaphragm 43 is formed of a flexible material such as rubber. The cross section of the switching diaphragm 43 is circular in shape. The switching diaphragm 43 has an outer edge 43a with a large cross section, a thin-walled portion 43b that is annular and has a smaller cross section than the outer edge 43a, a central valve body 43c whose cross section is larger than the thin-walled portion 43b, the thin-walled portion 43b, and the outer edge 43a, all molded together in this order in succession.

The first divider 41, the second divider 42, and the switching diaphragm 43 are assembled by fitting and fixing the outer edge 41b and the outer edge 42b so that the switching diaphragm 43 is interposed between them. In other words, the outer edge 43a of the switching diaphragm 43 is sandwiched by the outer edge 41b and the outer edge 42b. The interior of each of the body portion 41a of the first divider 41 and the body portion 42a of the second divider 42, respectively, is divided by the switching diaphragm 43, thereby isolating the first valve chamber 46 and the second valve chamber 49, preventing fluid circulation between the first valve chamber 46 and the second valve chamber 49. The displacement of the position of the central valve body 43c inside the switching valve 21 closes the opening at the end of the first inner extending cylinder 41d or the opening at the end of the second inner extending cylinder 42d. This action allows the central valve body 43c to shut off the flow of compressed air CA1 to the first discharge port 45 or the second discharge port 48. In other words, the central valve body 43c closes one of the openings at the end of the first inner extending cylinder 41d and the opening at the end of the second inner extending cylinder 42d and opens the other. Thereby, the central valve body 43c selectively shuts off the flow of compressed air CA1 to the first discharge port 45 and the second discharge port 48.

The first inflow cylinder 41c, or the first inlet 44, of the switching valve 21 is connected to the first reservoir 25 via a connecting hose 29f. The second inflow cylinder 42c of the switching valve 21, or the second inlet 47, is connected to the second reservoir 26 via a connecting hose 29g.

Each of the first storage valve 27 and the second storage valve 28 is configured to open at a pressure higher than the discharge pressure of the drive pump P. Since the first storage valve 27 and the second storage valve 28 have the same configuration, the details of the first storage valve 27 will be described in detail and the details of the second storage valve 28 will be omitted.

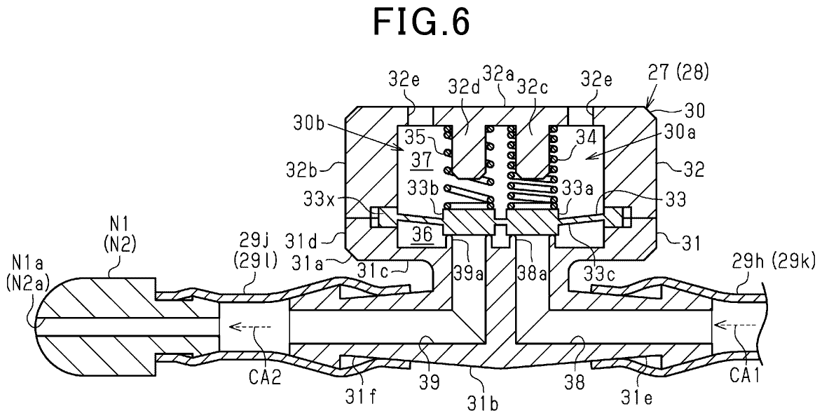

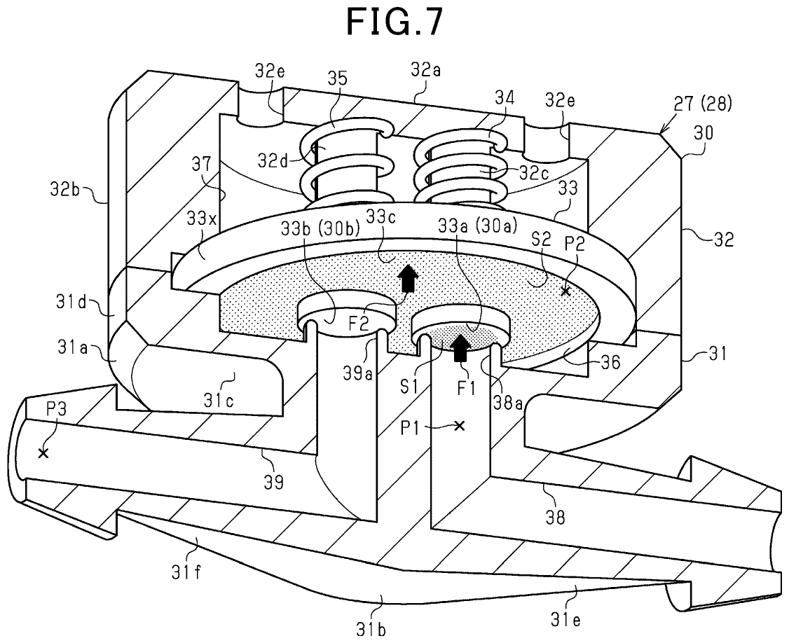

As shown in FIGS. 6 and 7, the first pressure storage valve 27 has a base member 31, a cover member 32, a diaphragm 33, a forcing spring 34 and a forcing spring 35. Of these components, a portion of the base member 31, the cover member 32, the diaphragm 33, and the forcing spring 34 and the forcing spring 35 constitute the valve body 30. Hereafter, the position of the base member 31 will be described as the lower side of the first pressure storage valve 27 and the position of the cover member 32 as the upper side of the first pressure storage valve 27, but the orientation of the first pressure storage valve 27 when in use is not limited to this.

The base member 31 is made of resin and has a base portion 31a at the upper portion and a connection part 31b at the lower portion. The base portion 31a constitutes the lower portion of the enclosure of the valve body 30. The base portion 31a has a circular bottom wall 31c and a circular side wall 31d extending upward from a peripheral portion of the bottom wall 31c. The cover member 32 constitutes the upper portion of the enclosure of the valve body 30. The cover member 32 has a circular upper wall 32a and a side wall 32b extending downwardly from a peripheral portion of the circular upper wall 32a. The base member 31 and the cover member 32 are assembled so that the upper end face of the circular side wall 31d and the lower end face of the side wall 32b are in contact with each other, and their end faces sandwich a peripheral edge 33x of the diaphragm 33. The peripheral edge 33x is pinched to provide a seal. The space formed by the diaphragm 33 and the bottom wall 31c and the circular side wall 31d of the base portion 31a is the valve chamber 36, and the space formed by the diaphragm 33 and the circular upper wall 32a and side wall 32b of the cover member 32 is the back pressure chamber 37.

The connection part 31b is provided on the underside of the base portion 31a and extends downward from the bottom wall 31c of the base portion 31a to form an inverted T shape. On one side of the connection part 31b is a pump side connection 31e, and on the other side is a nozzle side connection 31f. The inlet path 38 formed inside the pump side connection 31e and the discharge path 39 formed inside the nozzle side connection 31f are independent of each other. An opening 38a of the inlet path 38 and an opening 39a of the discharge path 39 are formed in the center of the bottom wall 31c respectively. Each of the opening 38a and the opening 39a protrudes cylindrically slightly above the bottom surface of the bottom wall 31c.

Diaphragm 33 is formed of a flexible material such as rubber. The cross section of the diaphragm 33 is approximately circular in shape. The diaphragm 33 has a first valve plug 33a which is approximately cylindrical in shape and a second valve plug 33b in the center of the diaphragm 33 at positions opposite the opening 38a and the opening 39a respectively. The first valve plug is an example of “valve plug” in the claims. The portions of the diaphragm 33 excluding the first valve plug 33a, the second valve plug 33b, and the peripheral edge 33x, i.e., the portions between the first valve plug 33a and the second valve plug 33b and the peripheral edge 33x, are configured as thin-walled portions 33c that are thinner than the first valve plug 33a, the second valve plug 33b and the peripheral edge 33x. Thereby, respective the first valve plug 33a and the second valve plug 33b of the diaphragm 33, which is connected via the thin-walled portion 33c to the fixed peripheral portion 33x, can be independently displaced. By the displacement action of each of the first valve plug 33a and the second valve plug 33b, the first valve plug 33a contacts or separates from the opening 38a of the inlet path 38 to open or close the inlet path 38, and the second valve plug 33b contacts or separates from the opening 39a of the discharge path 39 to open or close the discharge path 39.

The cover member 32 is made of resin and has a protruding portion 32c and a protruding portion 32d at each of the positions opposite to each of the first valve plug 33a and the second valve plug 33b in the circular upper wall 32a. Each of the protruding portion 32c and the protruding portion 32d regulates the position of the forcing spring 34 and the forcing spring 35 respectively, the springs being compression coil springs. The upper side of each of the forcing spring 34 and the forcing spring 35 is mounted to each of the protruding portion 32c and the protruding portion 32d. The upper ends of each of the forcing spring 34 and the forcing spring 35 contact the circular upper wall 32a. The lower ends of each of the forcing spring 34 and the forcing spring 35 contact each of the first valve plug 33a and the second valve plug 33b respectively. The forcing spring 34 originates from the circular upper wall 32a and forces the first valve plug 33a downward, i.e., it forces the first valve plug 33a toward the opening 38a of the inlet path 38. The forcing spring 35 originating from the circular upper wall 32a forces the second valve plug 33b downward, i.e., forces the second valve plug 33b toward the opening 39a of the discharge path 39. The force of the forcing spring 35 may be smaller than that of the forcing spring 34. The circular upper wall 32a may have two connecting holes 32e outside of each of the protruding portion 32c and the protruding portion 32d that connect (open to atmosphere) the back pressure chamber 37 to the outside of the cover member 32 so that the respective displacement movements of the first valve plug 33a and the second valve plug 33b, are not affected by the pressure in the back pressure chamber 37.

Of the valve body 30 of the first pressure storage valve 27 and the second pressure storage valve 28, the part closer to the inlet path 38 and the first valve plug 33a is described as the first valve part 30a and the part closer to the discharge path 39 and the second valve plug 33b is described as the second valve part 30b. The detailed operation of the first pressure storage valve 27 and the second pressure storage valve 28 is described below.

The pump side connection 31e of the first pressure storage valve 27 is connected to the first outer extending cylinder 41e of the switching valve 21 via a connection hose 29h. The nozzle side connection 31f of the first pressure storage valve 27 is connected to the first nozzle N1 via a connection hose 29j.

The pump side connection 31e of the second pressure storage valve 28 is connected to the second outer extending cylinder 42e of the switching valve 21 via a connection hose 29k. The nozzle side connection 31f of the second pressure storage valve 28 is connected to the second nozzle N2 via a connection hose 29l.

A jet N1a of the first nozzle N1 is positioned toward the sensing surface 11a (see FIG. 1) of the distance measuring sensor 11. The first nozzle N1 is capable of injecting high-pressure, pulse-shaped output air CA2 supplied from the first storage valve 27 toward the sensing surface 11a.

A jet N2a of the second nozzle N2 is positioned toward the sensing surface 12a (see FIG. 1) of the second distance-measuring sensor 12. The second nozzle N2 is capable of injecting high-pressure, pulse-shaped output air CA2 supplied from the second storage valve 28 toward the sensing surface 12a.

The first storage valve 27 is preferably located near the first nozzle N1 to minimize piping loss of output air CA2 generated by the first storage valve 27 to the first nozzle N1. The connection hose 29j connecting the first pressure storage valve 27 and the first nozzle N1 may be omitted, and the first pressure storage valve 27 and the first nozzle N1 may be integrally configured.

The second storage valve 28 should be located near the second nozzle N2 to minimize piping loss of output air CA2 generated by the second storage valve 28 to the second nozzle N2. The connection hose 29l connecting the second storage pressure valve 28 and the second nozzle N2 may be omitted, and the second storage pressure valve 28 and the second nozzle N2 may be integrally configured.

As shown in FIG. 1, the drive pump P is connected to and controlled by the ECU (Electronic Control Unit) 50. The operation and action of this system are described below.

For example, ECU 50 drives the drive pump P when adhesion of foreign matter such as raindrops on the sensing surfaces 11a, 12a is detected, when a predetermined time has elapsed, or when a switch is operated. The drive pump P outputs compressed air CA1.

Compressed air CA1 is continuously supplied to the switching valve 21 through the branch part 22, the first check valve 23, the second check valve 24, the first reservoir 25 and the second reservoir 26. As a result, in the switching valve 21, the central valve body 43c moves according to the pressure difference between the inside of the first valve chamber 46 and the inside of the second valve chamber 49, and the flow of compressed air CA1 to the first discharge port 45 or the second discharge port 48 is blocked. The central valve body 43c is initially positioned in the neutral position, and when a pressure difference occurs between the first valve chamber 46 and the second valve chamber 49 due to a difference in path, etc., the central valve body 43c moves in either direction to shut off the flow of compressed air CA1 to the first discharge port 45 or the second discharge port 48.

As shown in FIG. 5, when the pressure in the first valve chamber 46 increases, the central valve body 43c blocks the opening at the end of the second inner extending cylinder 42d to block the flow of compressed air CA1 to the second discharge port 48 and allows the flow of compressed air CA1 to the first discharge port 45. When the central valve body 43c blocks the second inner extending cylinder 42d, the pressure in the second inner extending cylinder 42d does not increase, so the central valve body 43c does not return to the neutral position and remains in position even if the pressure difference between the first valve chamber 46 and the second valve chamber 49 disappears. In other words, once the central valve body 43c blocks the second inner extending cylinder 42d, the area where the switching diaphragm 43 receives pressure in the second valve chamber 49 becomes smaller, so even if the pressure difference between the chambers disappears, the central valve body 43c remains in that position until the “product of area and pressure” difference reverses. The central valve body 43c moves to block the opening at the end of the first inner extending cylinder 41d when the difference in “the product of area and pressure” is reversed because the pressure in the second valve chamber 49 becomes much higher than the pressure in the first valve chamber 46, with the second inner extending cylinder 42d blocked.

In the initial non-operating state of the first pressure storage valve 27, the first valve portion 30a is completely in a closed valve state, i.e., the first valve plug 33a blocks the opening 38a of the inlet path 38, as shown in FIG. 6. In the initial non-operating state of the second pressure storage valve 28, the second valve portion 30b is completely in a closed valve state, i.e., the second valve plug 33b blocks the opening 39a of the discharge path 39, as shown in FIG. 6.

As shown in FIG. 5, when the pressure in the first valve chamber 46 becomes higher, compressed air CA1 is supplied to the first pressure storage valve 27 by allowing compressed air CA1 to flow to the first discharge port 45.

When compressed air CA1 is continuously supplied by the drive pump P, the pressure of compressed air CA1 in the first reservoir 25 increases as the first valve plug 33a is kept in a closed valve state by the force of the forcing spring 34, and the pressure P1 in the part of the first pressure storage valve 27 including the inlet path 38 and the connection hose 29h (hereinafter referred to as “pressure P1 on the introduction side”) increases. At this time, the pressure of compressed air CA1 in the second reservoir 26 also increases, but compressed air CA1 is not supplied to the second pressure storage valve 28. As shown in FIG. 7, in the first pressure storage valve 27, the pressure P1 on the introduction side acts on a relatively small area S1 in the first valve plug 33a that corresponds to the area of the opening 38a. The pushing force F1 acting on the first valve plug 33a is the product of the pressure P1 on the introduction side and the area S1, F1=P1×S1. The pressure P1 on the introduction side is increased to a pressure sufficiently higher than the discharge pressure of the drive pump P in the closed valve state. The discharge pressure of the drive pump P is the pressure in that flow path when the drive pump P is driven when the drive pump P and the first nozzle N1 are directly connected by a connecting hose (hereinafter simply referred to as “discharge pressure of the drive pump P”).

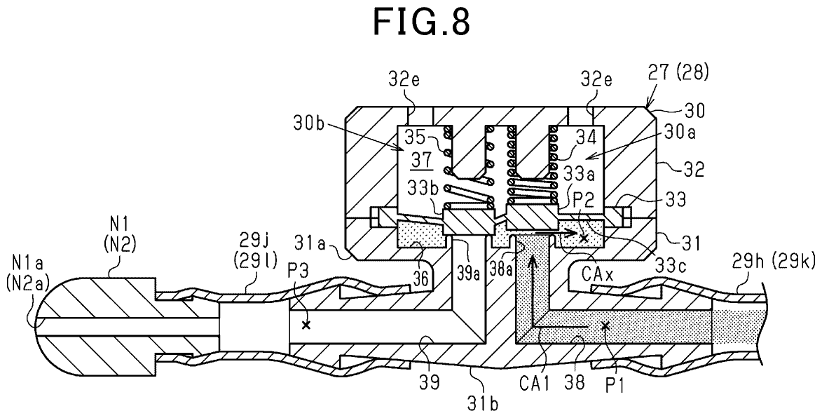

As the pressure P1 on the introduction side increases, in the first valve section 30a, a small gap is created between the first valve plug 33a and the opening 38a, as shown in FIG. 8, and a portion of the compressed air CA1 leaks slightly into the valve chamber 36 as leak air CAx. Therefore, the pressure P2 in the valve chamber 36 also gradually increases. The pressure P2 in the valve chamber 36 acts on a relatively large area S2, which corresponds to the area of the entire thin-walled portion 33c excluding the area of the opening 38a and the opening 39a, as shown in FIG. 7. In this case, the pushing force F2 acting on the thin-walled portion 33c is the product of the pressure P2 in the valve chamber 36 and the area S2, F2=P2×S2. Since the area S2 of the thin-walled portion 33c on which pressure P2 acts is wider than the area S1 of the first valve plug 33a on which pressure P1 acts, the influence as the pushing force F2 is large even if pressure P2 is lower than pressure P1.

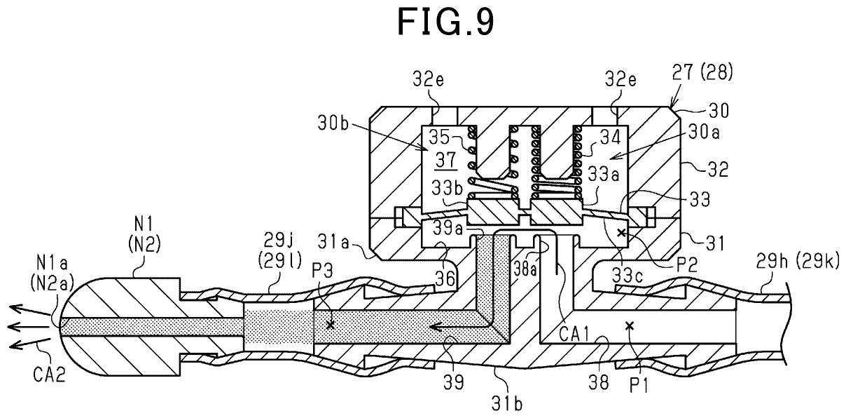

When both the pressure P1 on the introduction side and the pressure P2 in the valve chamber 36 increase, the pushing force “F1+F2” of the diaphragm 33, which is the sum of the pushing force F1 of the first valve plug 33a and the pushing force F2 of the thin-walled portion 33c, exceeds the prescribed pushing force (pushing forces of the forcing spring 34 and the forcing spring 35). As shown in FIG. 9, this causes a large displacement of the entire diaphragm 33, and both the first valve section 30a and the second valve section 30b become open. In other words, each of the first valve plug 33a and the second valve plug 33b is separated from each of the opening 38a and the opening 39a, and interior spaces of the inlet path 38, valve chamber 36 and discharge path 39 become connected.

Since the pressure P1 on the introduction side is sufficiently higher than the discharge pressure of the drive pump P and the high-pressure compressed air CA1 in the inlet path 38 flows at once through the valve chamber 36 to the discharge path 39, the pressure P3 on the discharge side increases rapidly. Thereby, high pressure air is supplied to the first nozzle N1 as the output air CA2.

On the other hand, the pressure P1 on the introduction side in the first pressure storage valve 27 decreases rapidly, and eventually, after the pressure P3 on the discharge side matches the pressure P1 on the introduction side, both pressure P3 and pressure P1 decrease, and the diaphragm 33 switches from the open valve state to the closed valve state. As a result, the pressure P2 in the valve chamber 36 also decreases, and the force of the forcing spring 34 and forcing spring 35 prevails over the pushing force of the diaphragm 33 “F1+F2,” based on the pressures P1 and P2, causing the first valve plug 33a to block the opening 38a of the inlet path 38 and the second valve plug 33b to block the opening 39a of the discharge path 39. Based on these actions, a high-pressure, pulsed output air CA2 is generated. As a result, the high-pressure, pulse-shaped output air CA2 is injected from the first nozzle N1 onto the sensing surface 11a of the first distance-measuring sensor 11. Thus, raindrops and other foreign matter that may adhere to the sensing surface 11a is effectively removed and cleaned.

As the pressure P1 on the introduction side at the first storage valve 27 decreases rapidly as described above, the pressure in the first reservoir 25 and the first valve chamber 46 of the first flow path R1 also decreases rapidly. At this time, the second check valve 24 prevents the backflow of compressed air CA1 in the second valve chamber 49 and second reservoir 26 to the branch part 22. The pressure in the second valve chamber 49 is then much higher than the pressure in the first valve chamber 46, which reverses the aforementioned “product of area and pressure” difference, and the central valve body 43c moves to block the opening at the tip of the first inner extending cylinder 41d. The timing at which the central valve body 43c moves may vary slightly depending on various conditions, such as the length of the connecting hose 29h, etc. For example, it may not necessarily be after the closing of the first valve plug 33a and the second valve plug 33b as described above but may be before the closing. In this way, the flow of compressed air CA1 is switched by the switching valve 21 from going to the first storage valve 27 to the second storage valve 28.

Then, in the second flow path R2, the second storage valve 28 operates in the same way as the first storage valve 27 operates, and high pressure, pulse-shaped output air CA2 is injected from the second nozzle N2 to the sensing surface 12a of the second distance-measuring sensor 12. Thus, raindrops and other foreign matter that may adhere to the sensing surface 12a is effectively removed and cleaned. The flow of compressed air CA1 is then switched again by the switching valve 21 to the state toward the first pressure storage valve 27, and the above operation is repeated. In this way, when compressed air CA1 is continuously supplied by the drive pump P, output air CA2 is alternately injected from the first and second nozzles N1 and N2, and both sensing surfaces 11a and 12a are cleaned well.

Hereinafter, the effects of the above embodiments are explained.
(1) Output air CA2 from either of the first or second nozzles N1 and N2 causes the pressure in the corresponding flow path to drop, which causes the flow of compressed air CA1 to switch to either of the first or second nozzles N1 and N2 by the action of the switching valve 21. Therefore, compressed air CA1 supplied from a single drive pump P can be mechanically switched from the first nozzle N1 and the second nozzle N2 to be injected as output air CA2. Therefore, the configuration can be simplified compared to a vehicle cleaning device equipped with a solenoid valve or the like. In detail, the system does not require a solenoid valve, wires connected to that solenoid valve, or a control unit to control the solenoid valve.
(2) The first reservoir 25 and the second reservoir 26 stabilize the amount and pressure of compressed air CA1 in the area between the first check valve 23 and the switching valve 21 and between the second check valve 24 and the switching valve 21. Thus, the switching of the flow of compressed air CA1 by the switching valve 21 can be stabilized and output air CA2 can be stably output from the first nozzle N1 and the second nozzle N2.
(3) The first valve portion 30a of the first storage valve 27 and the second storage valve 28 closes the inlet path 38 of compressed air CA1 with the first valve plug 33a and stores compressed air CA1 supplied from the drive pump P at a pressure higher than the discharge pressure of the drive pump P. The first valve section 30a, the second valve section 30b, the diaphragm 33, the valve chamber 36, etc., which also function as auxiliary mechanisms for the first pressure storage valve 27 and the second pressure storage valve 28, generate leakage air CAx of compressed air CA1 from the inlet path 38 to store pressure at the leak side (the valve chamber 36, etc.) during the above storage pressure. Next, the auxiliary mechanism opens the first valve plug 33a based on the pressure P1, P2 stored in the inlet path 38 and the leak side (valve chamber 36, etc.) to output the compressed air CA1 stored in the inlet path 38 to the discharge path 39. The first valve plug 33a is then closed again to allow storage of pressure in the inlet path 38 and based on the first valve plug 33a opening and closing operations, high-pressure, pulse-shaped output air CA2 is generated. In other words, the configuration and operation of the first pressure storage valve 27 and the second pressure storage valve 28, etc., can generate high-pressure, pulsed output air CA2.

This embodiment can be implemented with the following modifications. This embodiment and the following modifications can be implemented in combination with each other to the extent that they are technically consistent.

The configuration of the first pressure storage valve 27 and the second pressure storage valve 28 in the above embodiment is just an example, and may be changed as needed if the valve is configured to open at a pressure higher than the discharge pressure of the drive pump P.

For example, in the first pressure storage valve 27 and the second pressure storage valve 28, the second valve section 30b is configured with the same valve structure as the first valve section 30a, but a valve structure different from that of the first valve section 30a may be used for the second valve section 30b.

Although each of the first pressure storage valve 27 and the second pressure storage valve 28 is one configuration with two valve sections (the first valve section 30a and the second valve section 30b), it may be configured with two valve devices with a single valve section connected in series, for example. In this case, a check valve may be used on the downstream side.

In the above embodiment, the first pressure storage valve 27 and the second pressure storage valve 28 above, leakage air CAx of compressed air CA1 is generated between the first valve plug 33a and the opening 38a to be stored in the valve chamber 36. For example, an extremely small hole or slit connecting the inlet path 38 and the valve chamber 36, or a rough surface on the contact surface of the first valve plug 33a of the aperture 38a may be provided.

The configuration of the switching valve 21 in the above embodiment is just an example and may be changed as needed if the configuration has a similar function.

In the above embodiment, the vehicle cleaning device 20 has the first reservoir 25 and the second reservoir 26, but it is not limited to this. For example, it may be configured without the first reservoir 25 or the second reservoir 26. In cases where the connecting hose is long, etc., the connecting hose may perform the same function as the first reservoir 25 and the second reservoir 26.

In the above embodiment, the vehicle cleaning system 20 injects compressed air as a fluid into the first and second cleaning targets, but it may also inject a gas-liquid mixture or liquid. When a liquid is used, it is desirable to ensure that the liquid itself is also dispersed from the cleaning target.

In the above embodiment, the first distance-measuring sensor 11 and the second distance-measuring sensor 12 are located at the center of the front end and the center of the rear end of the vehicle 10, respectively, but they are not limited to this and may be located on the left and right sides of the vehicle 10, for example.

In the above embodiment, the sensing surface 11a and the sensing surface 12a are considered as the first cleaning target and the second cleaning target. For example, cameras that capture images of the surroundings of the vehicle 10, sensors other than these optical sensors, and sensors other than sensors, such as headlights, tail lamps, electronic side mirror cameras, cameras for checking the vehicle surroundings, etc. may be used as the first and second cleaning targets.

Although the above embodiment is embodied in the vehicle cleaning device 20, it may be embodied in other flow switching devices that can switch fluid output from the first output section and the second output section. That is, in the above embodiment, the first output section is the first nozzle N1 and the second output section is the second nozzle N2, but it is not limited to this, for example, the first and second output sections may be other elements and may be connected to other devices, etc.

Although this disclosure has been described in accordance with examples, this disclosure is not limited to the examples or structures. The present disclosure also encompasses various variations and transformations within the scope of equality. In addition, various combinations and forms, as well as other combinations and forms including only one element, more or less, thereof, also fall within the scope and idea of this disclosure.

What is claimed is:

1. A flow path switching device that can selectively output fluid supplied from a drive pump from either the first output section or the second output section, the device comprising:
a switching valve configured to, in response to a drop in pressure occurring in either of a first output section or a second output section, switch fluid flow to one of the first output section or the second output section in which the pressure drop did not occur.

2. The flow path switching device according to claim 1, further comprising:
a branch part connected to the drive pump that allows the fluid supplied by the drive pump to flow into either the first flow path or the second flow path;
a first check valve connected between the branch part and the switching valve in the first flow path to prevent backflow of the fluid into the branch part;
a second check valve connected between the branch part and the switching valve in the second flow path to prevent backflow of the fluid to the branch part;
a first pressure storage valve connected between the switching valve and the first output section in the first flow path and that opens at a pressure higher than the discharge pressure of the drive pump;
a second pressure storage valve connected between the switching valve and the second output section in the second flow path and that opens at a pressure higher than the discharge pressure of the drive pump.

3. The flow path switching device according to claim 2, further comprising:
a first reservoir connected between the first check valve and the switching valve in the first flow path and capable of storing the fluid;
a second reservoir connected between the second check valve and the switching valve in the second flow path and capable of storing the fluid.

4. The flow path switching device according to claim 2,
wherein each of the first storage valve and the second storage valve includes:
an inlet path for introducing the fluid;
a valve section including a valve plug configured to close the inlet path and to store the pressure of the fluid supplied from the drive pump to the inlet path at a pressure higher than the discharge pressure of the drive pump;
a discharge path for discharging the fluid; and
an auxiliary mechanisms, and
wherein, the auxiliary mechanism performs:
(1) causing leakage of the fluid from the inlet path when storing pressure by the valve section and storing pressure at a leak side due to the leakage;
(2) opening the valve body based on both pressures stored in the inlet path and at the leak side;
(3) outputting the fluid stored in the inlet path to the discharge path based on the opening of the valve body; and
(4) closing of the valve body, which allows the pressure to be stored again in the inlet path as a result of the output of the fluid to the discharge path.

5. The flow path switching device according to claim 1,
wherein the switching valve comprises:
a first inlet;
a first discharge port;
a first valve chamber which interior space is connected to interior space of the first inlet and interior space of the first discharge port,
a second inlet;
a second discharge port;
a second valve chamber which interior space is connected to interior space of the second inlet and interior space of the second discharge port; and
a switching valve body being set across the first valve chamber and the second valve chamber, that shuts off a flow of the fluid to the first discharge port or the second discharge port depending on the pressure difference between the first valve chamber and the second valve chamber.

6. A vehicle cleaning device including the flow path switching device according to claim 1, wherein
the first output section is a first nozzle for spraying the fluid to the first cleaning target, and
the second output part is a second nozzle for spraying the fluid to the second cleaning target.
